(19) United States
(12) Patent Application Publication
(10) Pub. No.: US 2009/0035627 A1
(43) Pub. Date: Feb. 5, 2009

(54) Method for gas storage, transport, and energy generation

(76) Inventors: Bahman Tohidi, Scotland (GB); Jinhai Yang, Scotland (GB); Anthony Chapoy, Scotland (GB); Ross Anderson, Scotland (GB); Mosayyeb Arjmandi, Scotland (GB)

Correspondence Address: INTELLECTUAL PROPERTY / TECHNOLOGY LAW, PO BOX 14329, RESEARCH TRIANGLE PARK, NC, 27709, US

(21) Appl. No.: 11/921,727

(22) PCT Filed: Jun. 7, 2006
(86) PCT No.: PCT/GB2006/002092

§ 371 Date: May 21, 2008

(30) Foreign Application Priority Data
Jun. 7, 2005 (GB) 0511546.4

(51) Int. Cl. H01M 8/18; B01D 15/08; C01B 31/20; F17C 11/00; C01B 3/00; B01D 53/02

(52) U.S. Cl. 429/19; 252/183.11; 423/437.1; 423/658.2; 585/899; 205/343; 95/139; 210/660; 206/7

(57) ABSTRACT

The invention provides semi-clathrate hydrate compositions formed from water, a semi-clathrate hydrate forming compound and a gas. The semi-clathrate hydrate forming compounds can be ammonium salts, sulphonium salts, phosphonium salts or amines. The semi-clathrate hydrate compositions can be used to store gases including hydrogen, methane and carbon dioxide. Methods of manufacture of the compositions and their uses in energy storage and generation, and for the separation of gases are also described.

### FIELD OF THE INVENTION

The present invention relates to the field of gas storage. The novel compositions and methods described herein are of particular applicability to the fields of energy storage, but are also applicable in other fields.

The present invention is particularly relevant to the fields of, gas storage and transport technology, energy conversion, energy storage for peak-shaving, heat pumps, selective gas separation, fuel cell technology and the automobile industry.

### BACKGROUND TO THE PRESENT INVENTION

Hydrogen is currently considered by many as the ‘fuel of the future’. It is particularly favoured as a replacement for fossil fuels due to its clean-burning properties, the waste product of combustion being only water.

The most common methods of hydrogen storage are through compression, storage of liquid at low temperatures, and storage as chemical compounds such as hydrides. Storage of gaseous hydrogen in pressure vessels is and will for the time being remain the most widely used method, although the low energy density of gaseous H₂ requires drastic compression to reach acceptable energetic properties. Liquid hydrogen storage is a mature technology, but the energy cost of liquefaction is a factor where improvement is needed. Storage of hydrogen in metal hydrides is a safe storage method, however, the weight penalty and the hydrogen capacity are difficult to overcome, and research on complex hydrides needs to go further. The cost of metal hydride storage alloys is also a factor of concern. Hydrogen storage in carbon nanotubes and nanofiber materials is an open question with many answers being required, such as those to solve conflicting experimental results and contradicting hydrogen capacities, in order to reduce the material cost. From the information available to date, activated carbon seems to be a promising material for H₂ storage, if new developments are made in the area of developing activated carbon with higher pore volume and higher BET surface area. Zeolites seem to have a too poor hydrogen storage capacity according to the current status of this technique to be viable. Glass microspheres show a high hydrogen capacity but require high pressures and temperatures.

### Storage in Clathrate Hydrates

A recent addition to the possible storage methods for hydrogen is the storage of the gas in clathrate hydrates. Clathrate hydrates are crystalline compounds formed by the physical combination of water molecules and suitably sized guest molecules, such as methane. The “guest” molecules occupy sites in the clathrate hydrate where they are surrounded by a cage like structure of bound together water molecules. Clathrate hydrates are well known to form with a range of gases including methane and carbon dioxide, when at appropriate concentrations, temperatures and pressures. This has led to their suggested use for the storage and transportation of these gases. However the preparation of clathrate hydrates containing hydrogen as the guest gas has proved more elusive. Clathrate hydrate structures often have different sized cavities or “cages”. Molecules such as propane and tetrahydrofuran (THF) are generally sited in relatively large cavities of a clathrate hydrate structure, with smaller cavities or cages partially filled with smaller molecules (e.g., methane, CO₂) or unoccupied.

Until recently, hydrogen was considered not to form ‘common’ (the term ‘common’ is used here to denote the well-know structures-I, II and H gas hydrates which occur, for example, in the seafloor and oil and gas pipelines) gas hydrates or clathrate hydrates (for example, methane hydrates).

Even in gas mixtures containing hydrate formers (for example, methane or propane), it was believed that hydrogen could not enter and stabilise the hydrate lattice, to form a relatively stable gas containing hydrate, due to its small molecular size, as described by Zhang et al. [4].

However, it has recently been demonstrated that hydrogen can form structure-II clathrate hydrates at very high pressures and low temperatures (around 300 MPa at 249 K) [1].

Mao and Mao [1] synthesised a hydrogen-water clathrate hydrate at 200-300 MPa and 240-249 K. Promisingly, this clathrate had a gas storage capacity of 5.3 mass % H₂. However, they only managed to preserve it at atmospheric pressures under cryogenic temperature conditions (77 K). At 300 MPa, they measured a dissociation temperature of 280 K. Florusse et al. [2] and Lee et al. [3] subsequently reported that the stability of hydrogen clathrate hydrates can be increased significantly by adding a second guest, namely tetrahydrofuran (THF), which is a hydrate promoter. They demonstrated that it may be possible to store hydrogen clusters within the clathrate lattice at moderate pressures and low temperatures. This technology has recently been patented for gas storage and is described in WO2005113424 [7].

When used as a hydrate promoter THF occupies the large cages of the clathrate structure and the H₂ occupies mainly the small cages as might be expected from its small size. The hydrate dissociation pressure of the clathrate at 279.6 K is 5 MPa (vs. 300 MPa at 280 K for pure H₂ clathrates [1]). Lee et al. [3] subsequently reported a series of experiments relating H₂ storage capacity to the concentration of THF aqueous solution, suggesting clathrates with up to 4.0 mass % H₂ could be formed at pressures of 12 MPa. However, so far these results have not been successfully repeated in other laboratories, raising questions over their validity.

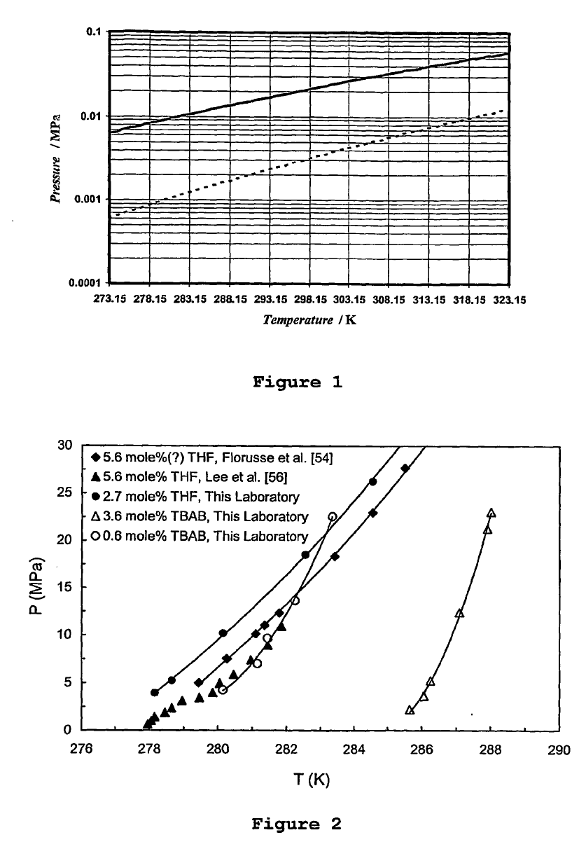

Although these results are promising, the storage of hydrogen as clathrate hydrates with additional stabilising gaseous or volatile liquid hydrate formers introduces problems. Ultimately, the decomposition of binary clathrate hydrates containing a volatile secondary guest to release hydrogen will also release volumes of the second guest (e.g. tetrahydrofuran), and thus an impure gas is produced, and so secondary separation will be required to produce a ‘clean’ fuel. For example THF, as utilised by Florusse et al. [2] is notably volatile (see FIG. 1 which illustrates water and THF vapour pressures as a function of temperature), and will be produced from the liquid phase upon dissociation, polluting the produced hydrogen steam. THF is a relatively harmful aromatic compound, raising additional health/safety and environmental concerns. Furthermore, pressure and temperature conditions for the formation of hydrogen-THF hydrates must be carefully controlled to ensure a hydrogen containing hydrate is formed (not just a THF hydrate).

In summary, the use of clathrate hydrates for hydrogen storage is currently in the initial stages of development and much more information is needed before this can be considered a viable option.

It is an object of the present invention to provide compositions and methods for the storage and use of gases that avoid at least one of the aforementioned disadvantages or limitations.

### DESCRIPTION OF THE PRESENT INVENTION

According to a first aspect the present invention provides a semi-clathrate hydrate composition comprising water, a gas and a semi-clathrate hydrate forming compound.

Semi-clathrate hydrates differ from common clathrate hydrates in that they include compounds which do not only become incorporated as ‘guest’ molecules in the clathrate hydrate ‘cages’ but also form part of the clathrate ‘cage’ structure, together with the water molecules. Thus the semi-clathrate forming compounds perform a dual function in a semi-clathrate hydrate composition, being incorporated into the structure, forming both part of the lattice and acting as ‘guest’ molecules hosted in structural cavities (hence their description as semi-clathrate hydrates) [5]. This is in contrast to common (s-I, s-II and s-H) gas hydrates, where the host lattice is comprised solely of water. In addition, semi-clathrates hydrates do not require the presence of guest gas molecules (e.g. hydrogen, methane) for stability, as common clathrate hydrates do and the compositions previously known do not comprise gases. A summary of the structures of known semi-clathrate hydrates of ammonium salts, alkyl-onium salts and alkylamines is provided by Jeffrey [5].

The semi-clathrate forming compound or a mixture of such compounds stabilises the structure and the formation of the structure by acting as the guest, typically in the large cavities of a semi-clathrate hydrate structure. A substantial number of known and potential semi-clathrate hydrate forming compounds (in excess of 200) are known. Preferably for the compositions of the invention they are ammonium salts, sulphonium salts, phosphonium salts or amines

It has been found that semi-clathrate hydrate structures can be formed which also comprise a gas, even such a difficult to enclathrate gas such as hydrogen, and which have useful properties. Preferably the gas is selected from the group consisting of hydrogen, methane and carbon dioxide.

A further advantage of the present invention is that a large number of the semi-clathrate forming compounds such as, for example, ammonium salts, phosphonium salts, and sulphonium salts are regarded as non-volatile compounds. These compounds generally reduce vapour pressure of water. This means the H₂ produced from the dissociation of semi-clathrate hydrates formed from water and ammonium salts, phosphonium salts and sulphonium salts will be almost unpolluted. This gives considerable advantages over THF—H₂ s-II common hydrates, where THF, a volatile, toxic, potentially carcinogenic compound may be produced in the gas stream. The high volatility of THF may additionally cause changes in the aqueous composition and thus hydrate stability through time. In contrast, ammonium salts phosphonium salts, and sulphonium salts are non-volatile, thus losses during clathrate dissociation are nearly zero, with only water, which is easily replenished, being lost in small quantities.

There are a large number of ammonium salts, phosphonium salts, sulphonium salts and amines (in excess of 200 examples are known) which are known to or can potentially form/stabilise semi-clathrate hydrates of varying structures depending on water to salt ratios, some of which are examined in detail below. The ammonium, phosphonium and sulphonium salts can be called “onium” salts. A majority of the onium salts and amines known to form semi-clathrate hydrates are alkylonium salts or alkylamines. A core part of the invention is the ability to vary the semi-clathrate hydrate forming compound or compounds used and their concentration relative to the aqueous phase. Selection of a suitable mixture of water and semi-clathrate hydrate forming compound will, for a given gas, allow the formation of a semi-clathrate hydrate composition which will include the gas. Optimal gas uptake and/or pressure and temperature stability of the semi-clathrate hydrate composition can be adjusted by varying the concentration of the components of the composition or changing the semi-clathrate hydrate forming compounds(s) employed. For the present invention, aqueous concentrations of between 0 and 50 mole % of semi-clathrate hydrate forming compounds are preferred.

The semi-clathrate hydrate forming compounds of the present invention are preferably an ammonium salt, sulphonium salt or phosphonium salt of the general formula I:

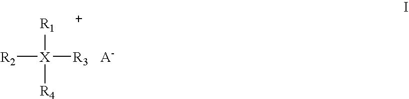

wherein X is N, P or S and R⁴ is absent when X is S; R¹, R², R³, and R⁴ are selected, independently, from the group consisting of hydrogen, C₁ to C₁₈ straight chain, branched or cyclic hydrocarbons, and an aryl group; and, A is an anion selected from the group consisting of, Bromide, Chloride, Fluoride, Hydrogen Sulfate, Hydroxide, Iodide, Methosulfate, Nitrate, Nitrite, Perchlorate, Sulphate and Carboxylate; or the semi-clathrate hydrate forming compound is an amine compound of general formula II:

NR¹R²R³ II

wherein R¹, R², and R³ have the same meaning as in formula I.

Examples of suitable R groups include Amyl, Benzyl, Butyl, Cetyl, Decyl, Dodecyl, Ethyl, Hexyl, Methyl, Myristyl, Nonyl, Octyl, Pentyl, Phenyl, Propyl, and Stearyl. However, the present invention is not intended to be construed as being limited to these preferred examples.

Advantageously the compositions of the invention are formed on a porous substrate, which can further enhance the kinetics/stability of the reaction/composition. For example an activated carbon or porous silica may be used.

As discussed above, Florusse et al. [2] suggested that the hydrogen storage capacity of THF-hydrogen hydrates could be up to 4 mass % H₂, but failed to give details on origins of this estimate. Subsequently, Lee et al [3] reported the apparently successful formation of a 4 mass % H₂ s-II binary clathrate hydrate from 0.15 mole % THF solutions. However, the results of these authors are apparently unrepeatable, raising questions regarding whether THF—H₂ hydrates present a suitable candidate for hydrogen storage. For clathrates hydrates of ammonium salts, alkyl-onium salts or alkylamines, it could be possible to achieve a similar or better figures to those for THF—H₂ hydrates (>4 mass %). Indeed, preliminary results generated in this laboratory (Heriot-Watt University, Edinburgh, UK) demonstrate the hydrogen storage capacity of THF-hydrogen hydrate at ˜25 MPa to be 0.29 mass %, while for Tetrabutylammonium bromide (TBAB)-hydrogen semi-clathrate hydrate at 20 MPa this value is 0.40 mass %. The characteristic phase boundary diagrams for these compositions are described hereafter as Examples.

According to a further aspect the present invention provides a method for the manufacture of a semi-clathrate hydrate composition comprising the steps of: providing a mixture of water and a semi-clathrate hydrate forming compound; and cooling or pressurising the mixture in the presence of a gas until a semi-clathrate hydrate composition comprising the gas is formed.

The formation of semi-clathrate hydrates incorporating a gas is a relatively simple procedure. For example, semi-clathrate hydrates of ammonium salts, alkyl-onium salts, or alkylamines can be formed simply by cooling (at atmospheric or higher pressures) or increasing the system pressure of an appropriate water-ammonium salt/alkyl-onium salt/alkylamines mixture of suitable ammonium salts/alkyl-onium salts/alkylamine concentration to within the appropriate semi-clathrate pressure/temperature (PT) stability region. The invention is not specifically limited to a particular ammonium salt/alkyl-onium salt/alkylamine, or particular pressure/temperature condition, or achieved gas concentration within the semi-clathrate, but rather the invention allows for all of these parameters to be adjusted to suit the particular application. For examples of the present invention, between 0 and 50 mole % ammonium salt, alkyl-onium salt, or alkylamine relative to water is preferable, although any degree concentration can be employed in order to give the appropriate level of achieved gas concentration.

Nucleation and solid phase crystallisation generally require only low degrees of subcooling within the semi-clathrate stability region. To incorporate gas into the semi-clathrate hydrate structure, the semi-clathrate is formed in the presence of the said gas under the pressure of this gas. For example, the aqueous water-ammonium salt/alkyl-onium salt/alkylamine mixture/solution and gas are cooled together (or subjected to increasing gas pressure) until system conditions enter the pressure/temperature thermodynamic stability region for the particular gas-water-ammonium salt/alkyl-onium salt/alkylamines salt semi-clathrate hydrate. Semi-clathrate formation is generally indicated by a reduction in system pressure (in a constant volume vessel) as gas is taken into the semi-clathrate structure (i.e. the bulk density of the system is increased). Reaction is promoted by mixing/agitation of the system.

According to a further aspect the present invention provides a method for storage or transportation of a gas comprising the steps of: preparing a semi-clathrate hydrate composition comprising the gas; and storing or transporting the said semi-clathrate hydrate composition under suitable pressure and temperature conditions to prevent decomposition.

The semi-clathrate hydrate compositions comprising a gas, of the invention have particularly advantageous physical properties as described hereafter with reference to the Examples. Thus the invention provides a method whereby gases, in particular hydrogen and methane, can be stored in a compressed form as inclusion molecules (enclathrated) within structural cavities of crystalline solid semi-clathrate hydrates formed, for example from a combination of water and ammonium salts, onium salts or amines at low pressures (potentially atmospheric) and moderate temperature conditions for the purposes of gas storage and/or transportation. The present invention is relevant to the fields of, gas storage and transport technology, energy conversion, energy storage for peak-shaving, heat pumps, selective gas separation, fuel cell technology and the automobile industry.

Amongst other uses, the present invention will allow for the storage and/or transport of large volumes of gases, in particular, but not limited to, hydrogen and methane, at low pressures and temperatures close to ambient.

The present invention provides improved means of gas storage utilising a class of compounds similar to common gas hydrates, namely and preferably semi-clathrate hydrates of ammonium salts, alkyl-onium salts or alkylamines, for the purposes of gas storage and/or transportation.

As water-onium salt/amines are generally water soluble, their mixtures with water are commonly single phase. When hydrates are formed, the system is almost incompressible when no gas phase is present or all gas has been consumed. Thus a gas can therefore be readily stored or transported in a solid form. Semi-clathrate dissociation, and gas release from the structure, may be induced when required by heating and/or decreasing system pressure until pressure/temperature conditions are out with those of the thermodynamic stability region for the semi-clathrate hydrates.

Clathrate formation and dissociation conditions can be determined by heating/cooling or increasing/decreasing pressure until the solid phase appears/disappears, as indicated by pressure/temperature relations (in a constant volume vessel), or by other means of detection including, but not exclusively, visual observation, changes in gas/water composition and/or changes in physical properties of the gas and/or liquid phase (e.g. resistivity). Following semi-clathrate formation under moderate to high gas pressures, pressure may be reduced to low (in some cases atmospheric) pressures without decomposition of the solid phase as long as system pressure/temperature (PT) conditions remain within the thermodynamic stability region for the particular semi-clathrate. This allows a gas to be kept under moderate conditions once the semi-clathrate hydrate composition has been formed.

The present invention includes the application of the above gas storage/compression method to the storage of hydrogen for use in hydrogen fuel cells, and particularly for utilisation in powering motor vehicles, but is not limited to such applications. It could also be used for transportation of gas/hydrogen in the form of solid hydrates in bulk containers or pipelines in the form of solid hydrates or hydrate slurries.

The present invention also includes the application of the above method of gas storage to provide a means for energy storage, through the storage of gas, for example air, in pressure vessels, preferably cylinders, containing a semi-clathrate hydrate of, for example an ammonium salt, alkyl-onium salt or alkylamine. An energy source is used to provide the necessary compression to form solid hydrates. Preferably, this energy comes from excess available due to overproduction, for example when the demand for energy from a power grid system is exceeded by the supply or from renewables (for example, wind, wave, solar, tidal energies), when otherwise this energy would be wasted. The heat generated during hydrate formation (an exothermic reaction) could also be used to provide a heating source, for example for buildings. When the energy stored within the solid hydrate is required, the hydrates are allowed to dissociate, either through a reduction in storage vessel pressure, or an increase in temperature, or both. The dissociating hydrates could then be used to drive a turbine, due to the release of (formerly compressed within the clathrate structure) high pressure gases, while the low temperatures generated during semi-clathrate dissociation (an endothermic reaction) could be used for cooling, for example to help drive an air conditioning system and/or condensing fresh water from air. This would provide as part of the present invention a novel method for ‘peak-shaving’ in energy sources and systems.

It is also possible to use the extra electricity from renewables or power grid to produce hydrogen by known methods of electrolysis. The produced hydrogen could be subsequently stored in the form of ammonium salt/alkyl-onium salt/alkylamines semi-clathrate hydrates. The required compression energy could be provided by using the extra electrical power or part of the produced hydrogen, or conducting the electrolysis under a hydrostatic head of water (electrolysis of water at high depths could eliminate the need for compression. However, this should be checked against the effect of pressure on the performance of electrolysis, as well as the effect of seawater on the electrodes). The produced hydrogen hydrates from offshore sites could be transferred to onshore facilities in the form of hydrates, in bulk, or in pressurised vessels, and/or in form of hydrate slurries through pipelines (e.g., from offshore platforms, semi-submersibles and FPSO (Floating Production, Storage and Offloading vessels) at the end of oil production life). This invention could be of particular interest to decommissioning of offshore facilities with the purpose of using them in producing, storage, and transportation of hydrogen from renewable sources. A typical scenario could be installing a wind farm on an abandoned oil platform. It could be possible to produce hydrogen through electrolysis using the electricity generated, form semi-clathrate hydrates at low and moderate pressures using the pressure vessels in offshore facilities, and transport hydrates in the form of cargo and/or moderate pressure hydrate slurries by using the existing pipelines. It should be noted that offshore oil production facilities (in particular remote ones) are generally independent and self-sufficient from power generation viewpoint and do not have electrical power cables connecting them to onshore facilities. Therefore, conversion of them to wind farms or other renewable energy sources necessitates installation of power cables or other means of energy transfer. However, these offshore facilities all have pipelines or some other means of transferring oil and/or gas to onshore facilities. The innovation described in this application could potentially eliminate the need for installing electrical power transmission cables for transferring electricity generated from renewable sources to onshore facilities and grid network, improving the economics of such ideas and reducing the time required for bring then into service. Furthermore, the present innovation could provide an alternative means for transfer of energy from onshore renewable sources to the users. For example, the power generated from wind farms in North of Scotland could be used to produce hydrogen, which in turn could be transported (e.g., pipelines) to the users in central Scotland.

The present innovation could be used for energy conversion by utilising the heat generated during hydrate formation and the heat absorbed during hydrate dissociation. The fact that a semi-clathrate could be formed at relatively high temperature and low pressure conditions, in addition to the relative incompressibility of these compounds, could be used in energy storage and conversion. For example, it is possible to cool the clathrate hydrate forming systems during excess electrical supply and form hydrates. These hydrates could be later dissociated and the endothermic reaction could be used for air conditioning. Alternatively, the clathrate hydrates could be dissociated by heating during periods of excess electricity supply. The reformation of clathrate hydrates will result in heat release which can be used for heating. In addition to electricity, the thermal energy required for hydrate formation and dissociation could be supplied from other sources for example, from solar sources or simply cold temperatures during periods of darkness or cold weather). The main enabling factor contained within the present invention with regard to these technologies is its ability to form hydrates at relatively low pressure and moderate temperature conditions by adjusting the composition of semi-clathrate hydrate forming water-ammonium salt/alkyl-onium salt/alkylamine mixtures/solutions. Furthermore, as the aqueous mixtures/solutions of ammonium salt/alkyl-onium salt/alkylamine are relatively incompressible, it is possible to initiate clathrate hydrate formation and dissociation by changing the system pressure. For some applications (e.g., gas transport in the form of hydrate slurry as detailed above), it would be preferable to form slurry clathrate hydrates by either controlling the formation conditions or adding suitable chemicals.

Furthermore, the present invention includes a method for the selective storage of gases, and therefore a method for the selective separation of gases. By adjusting the type of ammonium salt/alkyl-onium salt/alkylamines, and ammonium salt/alkyl-onium salt/alkylamines to water ratios, water cavity sizes within the semi-clathrate hydrate of ammonium salt formed are adjusted. As only certain gases can be accommodated within certain semi-clathrate cavities, adjusting clathrate cavity dimensions by the means described above will allow for the selective removal of a gas (or gases) from a gas mixture, this being taken up the by the semi-clathrate hydrate. Subsequent separation then dissociation of the solid semi-clathrate hydrate will thus yield a highly concentrated or purified form of the selected gas. This could have many applications, including but not limited to CO₂ separation from flue gases, hydrogen separation from by-products of H₂ production reactions (e.g. separation from CO₂ following natural gas reformation), and possibly combined with its transportation in the form of hydrate slurry to storage sites.

In addition to this, the present invention includes a method for removing impurities from an aqueous phase, such as removing methyl-blue dye from water. In this case the methyl blue (or similar chemical impurities) are taken up by the semi-clathrate hydrate of ammonium salt/alkyl-onium salt/alkylamine and so are selectively removed from the aqueous phase. Subsequent removal of the solid semi-clathrate hydrate from the original aqueous liquid will thus yield a purified form of this liquid.

### PARTICULAR EMBODIMENTS AND EXAMPLES OF THE PRESENT INVENTION

Semi-clathrate hydrates of the invention can be simply prepared by the following method. Their properties, for example disassociation characteristics can then be readily studied.

To incorporate gas into the clathrate structure, a pressure vessel of suitable pressure rating is used. An appropriate volume of liquid and gas are cooled together into the clathrate stability region under pressure until hydrate formation occurs (generally indicated by a reduction in the system pressure as gas is consumed). Reaction is promoted by mixing the system. Clathrate dissociation conditions can be determined by heating the system until the solid phase disappears, as indicated by pressure/temperature relations (or other means of detection).

FIG. 2 shows phase boundary curves for hydrogen containing clathrates. Those for H₂+H₂O+THF s-II common clathrates are found in references 5 and 6 and are compared to that for H₂+H₂O+Tetrabutylammonium bromide (TBAB) semi-clathrates (at 3.6 mol % and 0.6 mol % concentration of TBAB) as examples of the compositions of the invention. In this case, the increased stability of TBAB-H₂ semi-clathrates at low pressures compared to THF—H₂ s-II hydrates is clear. In particular the clathrate containing 3.6 mol % TBAB (i.e. 43 wt %) shows stability at temperatures of about 285K even at pressures as low as 2 MPa.

This shows that compounds which form part of the present invention have the advantage of being stable at lower (potentially atmospheric) pressures and temperatures much closer to ambient (˜283.15 K) when compared with other gas storage methods, including storage as common clathrate hydrates, as illustrated in FIG. 2.

This is further illustrated by considering semi-clathrate hydrates, with or without hydrogen at other concentrations of TBAB in water.

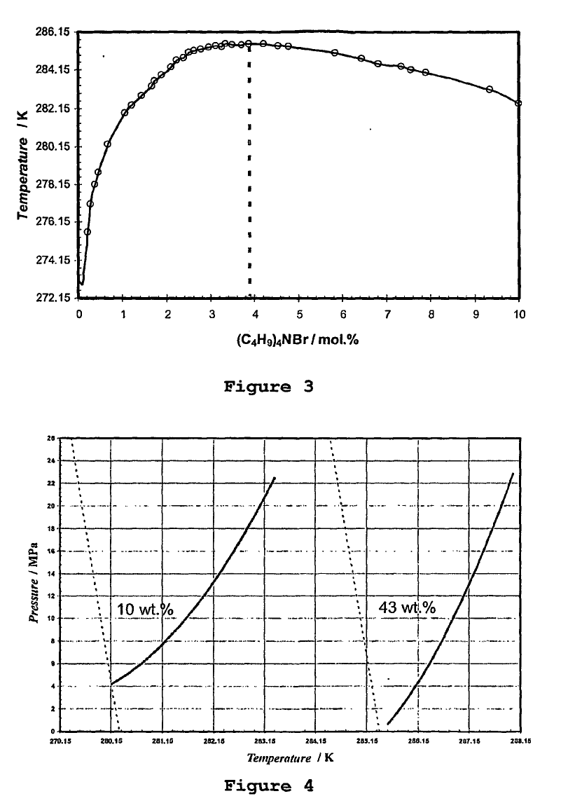

Tetrabutylammonium bromide is a member of the peralkylonium salt family, and is known to form a number of different (in terms of water to salt ratios and structures) semi-clathrate hydrates at atmospheric pressures over a range of aqueous salt concentrations, as discussed by Lipkowski et al. [6]. FIG. 3 shows a phase diagram for the system TBAB-H₂O in the region of crystallisation of clathrate polyhydrates utilising the data from Lipkowski et al. [6].

The TBAB clathrate with the highest dissociation temperature at 1 atmosphere forms from solutions of 4 mol % TBAB. Dissociation conditions for hydrogen-TBAB hydrates have been measured in the laboratory for two different concentrations of TBAB in water (10 and 43 mass % aqueous solutions). Data is presented in FIG. 4, which shows hydrate phase boundaries for H₂+H₂O+TBAB (solid lines) and TBAB+H₂O (dashed lines) systems at 10 and 43 mass % TBAB in the aqueous phase. The hydrogen containing hydrates show markedly greater stability, with the phase boundary being moved towards higher temperatures especially at increased pressure.

The presence of TBAB in aqueous solution reduces the water vapour pressure to similar or lower values than that which are seen for aqueous solutions of CaCl₂. This means that a vapour phase present in the system TBAB-H₂O—H₂ will be highly rich in hydrogen, with minimal water content and ammonium salt levels effectively zero. In pure water, hydrogen is highly insoluble (at P=5 MPa and T=298.15 K, X_{H2}≈6.6×10⁻⁴, and at P=1 atm and T=298.15 K, X_{H2}≈1.4×10⁻⁵). Similar values are expected for ammonium salt/alkyl-onium salt/alkylamine solutions, thus minimal hydrogen will remain within the aqueous phase upon semi-clathrate dissociation; the bulk of the hydrogen being released as a free, high-purity gas phase.

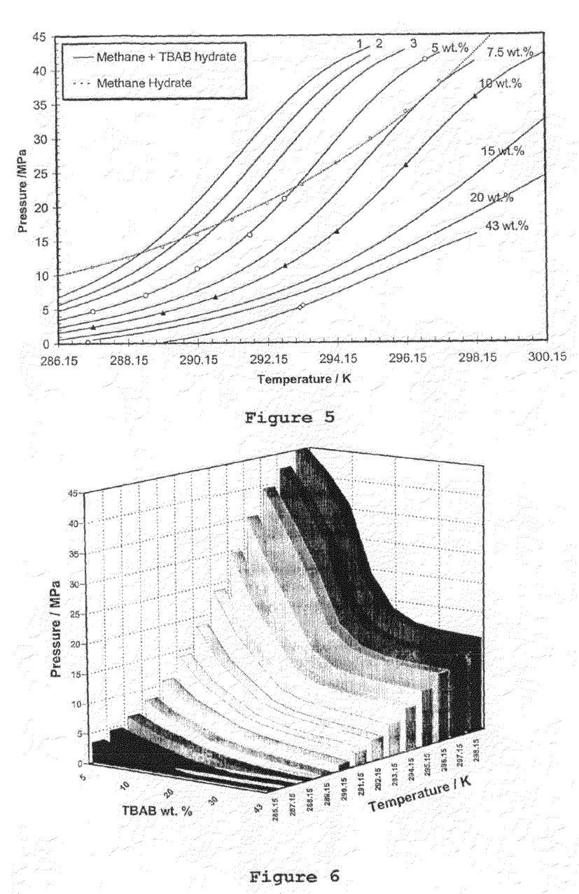

Methane-TBAB hydrates have also been prepared as examples and their properties examined. Dissociation conditions for methane-TBAB hydrates have been measured for four different concentrations of TBAB in water (5, 10, 20 and 43 mass %). FIG. 5 presents a comparison of both measured and predicted (by extrapolation by artificial neural network) CH₄⁺H₂O+TBAB dissociation conditions with those of pure (sI) methane-water hydrates. TBAB-methane semi-clathrate hydrates are considerably more stable (i.e., at much lower pressures and higher temperatures) than s-I common methane hydrates. A phase diagram for the system CH₄+H₂O+TBAB, predicted through extrapolation of the measured data using an artificial neural network, is shown in FIG. 6.

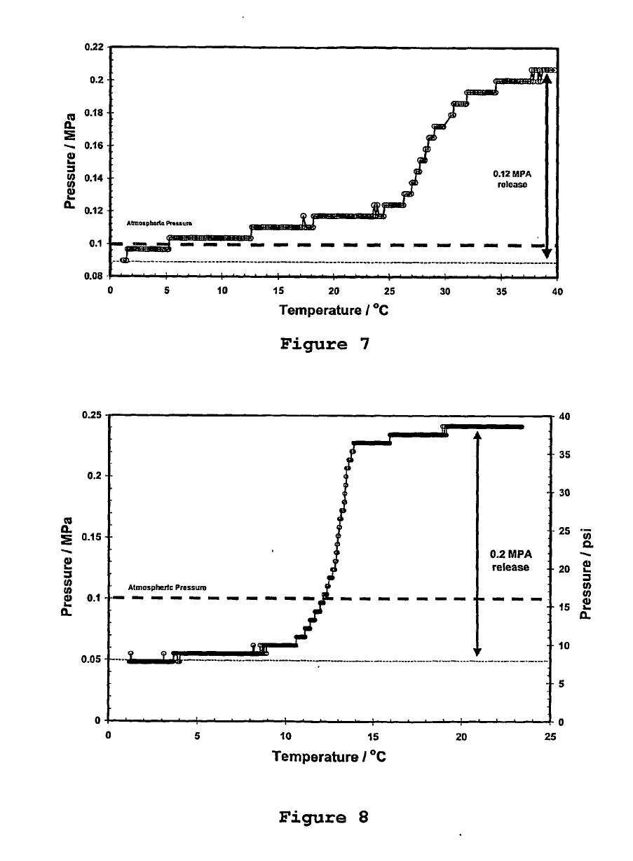

An important part of the invention is that CH₄ and H₂ hosting semi-clathrates are preserved at low and even atmospheric pressures. Decomposition and gas release only occur following heating to higher temperatures (i.e. heating outside the particular semi-clathrate pressure/temperature stability region), as supported by the results of experiments conducted on TBAB and TBAF (tetrabutylammonium fluoride) semi-clathrate hydrates. FIG. 7 shows pressure and temperature relations for the disassociation of H2+TBAF(Tetrabutylammonium Fluoride) hydrate at 35 wt % TBAF in water. The disassociation of the semi-clathrate hydrate is shown from initial pressure conditions of <1 atmosphere. System pressure is seen only to rise on heating when decomposition then begins and hydrogen is released. FIG. 8 which shows pressure and temperature relations for CH₄+TBAB hydrate (at 43 wt % TBAB in water) dissociation from initial pressure conditions of <1 atmosphere, where again system pressure is seen only to rise upon heating/decomposition, when methane is subsequently released.

The fact that heating, not depressurisation is required to release hydrogen (and other gases) from the semi-clathrate hydrate structure offers considerable advantages—particularly with regard to health and safety with concerns for flammable/explosive gases such as hydrogen and methane—over other methods of gas storage, which require moderate to very high-pressure storage conditions. For example, fracturing of a vessel containing hydrogen semi-clathrate hydrates of ammonium salts will not result in explosive gas release, rather a further substantial sustained heat input would be required to cause hydrate dissociation and slow gas release.

The present invention could also be utilised for ‘peak-shaving’ in natural gas production and consumption. Natural gas is mainly methane. The present invention can be used to form methane-ammonium salt/alkyl-onium salt/alkylamine semi-clathrate hydrates at high temperature conditions (relative to the temperature conditions normally necessary to form methane hydrates) when gas supply is higher than demand. The produced semi-clathrate hydrates can then be dissociated, producing natural gas when the demand is higher than supply. Similarly, the present invention can be applied to gas storage and transportation, as it enables the storage of natural gas in a compressed form as semi-clathrates and facilitates the transport of these gas hydrates as they are solid materials, therefore reducing the cost of gas transportation and improving the economics of stranded gas reservoirs.

### BENEFITS OF THE PRESENT INVENTION

The present invention enables the storage of hydrogen and other gases in a compressed form at moderate pressure and temperature conditions. The present invention offers benefits in terms of safety and cost, and also facilitates a reduction in greenhouse gas emissions. The present invention, as a gas storage method, offers losses of hydrogen which are theoretically nil if the clathrate hydrate dissociation pressures/temperatures are not reached.

As the ammonium salt/onium salt/amine compounds preferably involved in the present invention which are used to form semi-clathrate hydrates have a very low vapour pressure, contamination of the vapour phase of the stored gas should be minimal. As the present invention preferably utilizes ammonium salt/onium salt/amines which are water soluble, their mixtures with water are generally single phase. When semi-clathrate hydrates are formed the system is almost incompressible, so it is very easy to alter the system pressure to facilitate dissociation.

### REFERENCES

[1]. W. L. Mao and H-k. Mao, Hydrogen storage in molecular compounds, Proceedings of the National Academy of Sciences of the United States of America (2004) 101 (3), 708-710.
[2]. L. J. Florusse, C. J. Peters, J. Schoonman, K. C. Hester, C. A. Koh, S. F. Dec, K. N. Marsh, and E. Dendy Sloan, Stable Low-Pressure Hydrogen Clusters Stored in a Binary Clathrate Hydrate, Science (2004) 306, 469-471.
[3]. H. Lee, J.-W. Lee, D. Y. Kim, J. Park, Y-T. Seo, H. Zeng, I. L. Moudrakovski, C. I. Ratcliffe, J. A. Ripmeester, Tuning clathrate hydrates for hydrogen storage, Nature (2005) 434, 743-746.
[4]. Zhang, G-J. Chen, Q-L. Ma, L. Y. Yang, T-M. Guo, Hydrate Formation of Hydrogen+Hydrocarbon Gas Mixtures, Journal of Chemical and Engineering Data (2000) 45, 908-911.
[5]. G. A. Jeffrey, Hydrate Inclusion Compounds. In: J. L. Atwood, J. E. D. Davies and D. D. MacNichol. Inclusion Compounds, Academic Press, London, 1: 135-190.
[6]. J. Lipkowski, V. Yu. Komarov, T. V. Rodionova, Y. A. Dyadin, L. S. Aladko, The Structure of Tetrabutylammonium Bromide Hydrate (C₄H₉)₄NBr.2⅓H₂O, Journal of Supramolecular Chemistry, 2 (2002) 435-439
[7]. C. J. Peters, and E. Dendy Sloan, Hydrogen storage, 8 Apr. 2005, WO2005113424.

1. A semi-clathrate hydrate composition comprising water, a gas and a semi-clathrate hydrate forming compound.

2. A semi-clathrate hydrate composition according to claim 1 wherein the semi-clathrate hydrate forming compound is selected from the group consisting of ammonium salts, sulphonium salts, phosphonium salts and amines.

3. A semi-clathrate hydrate according to claim 2 wherein the semi-clathrate hydrate forming compound is an ammonium salt, sulphonium salt or phosphonium salt of the general formula I: 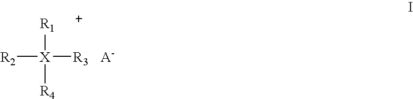
wherein X is N, P or S and R⁴ is absent when X is S; R¹, R², R³, and R⁴ are selected, independently, from the group consisting of hydrogen, C₁ to C₁₈ straight chain, branched or cyclic hydrocarbons, and an aryl group;
A is an anion selected from the group consisting of Bromide, Chloride, Fluoride, Hydrogen Sulfate, Hydroxide, Iodide, Methosulfate, Nitrate, Nitrite, Perchlorate, Sulphate and Carboxylate;
or the semi-clathrate hydrate forming compound is an amine compound of general formula II:
NR¹R²R³ II
wherein R¹, R², and R³ have the same meaning as in formula I.

4. A semi-clathrate hydrate composition according to claim 1 comprising a mixture of said semi-clathrate forming compounds.

5. A semi-clathrate hydrate composition according to claim 1 wherein the gas is selected from the group consisting of hydrogen, methane and carbon dioxide.

6. A semi-clathrate hydrate according to claim 1 wherein the total concentration of semi-clathrate hydrate forming compounds present is at up to 50% relative to the water content.

7. A semi-clathrate hydrate composition according to claim 1 wherein the gas is hydrogen, methane or carbon dioxide and the semi-clathrate hydrate forming compound is tetrabutyl ammonium bromide or tetrabutyl ammonium fluoride.

8. A method for the manufacture of a semi-clathrate hydrate composition comprising the steps of: providing a mixture of water and a semi-clathrate hydrate forming compound; and cooling or pressurising the mixture in the presence of a gas until a semi-clathrate hydrate composition comprising the gas is formed.

9. A method according to claim 8 wherein the mixture is agitated during the formation of the said semi-clathrate hydrate composition comprising a gas.

10. A method for storage or transportation of a gas comprising the steps of:
preparing a semi-clathrate hydrate composition comprising the gas; and
storing or transporting the said semi-clathrate hydrate composition under suitable pressure and temperature conditions to prevent decomposition.

11. A method according to claim 10 wherein the gas is selected from the group consisting of hydrogen, methane or carbon dioxide.

12. A method according to claim 10 wherein the semi-clathrate hydrate composition comprising the gas is prepared as a flowable slurry by use of excess water.

13. A method of transporting a gas according to claim 12 wherein the flowable slurry is transported along a pipeline.

14. A method of energy storage comprising the steps of:
using an energy source to compress and/or cool a mixture of a gas, water and at least one semi-clathrate hydrate forming compound to form a semi-clathrate hydrate composition comprising the gas; and storing the semi-clathrate hydrate composition;

15. A method of energy storage according to claim 14 wherein the gas is hydrogen, methane, carbon dioxide or air.

16. A method of energy generation comprising the steps of: storing energy by means of the method of claim 14;
decomposing the semi-clathrate hydrate composition comprising the gas; and
generating energy from the resulting gas pressure.

17. A method of energy generation according to claim 16 wherein the semi-clathrate hydrate composition is decomposed by heating and/or reduction in pressure.

18. A method of energy generation according to claim 16 wherein the gas pressure is used to drive a turbine.

19. A method of energy generation according to claim 16 wherein the exothermic nature of semi-clathrate hydrate formation is used to provide heating.

20. A method of energy generation according to claim 16 wherein the endothermic nature of semi-clathrate hydrate decomposition is used to provide cooling.

21. A method of energy generation comprising the steps of: obtaining a combustible gas; preparing a semi-clathrate hydrate composition comprising the gas, water and at least one semi-clathrate hydrate forming compound; storing the semi-clathrate hydrate composition; decomposing the semi-clathrate hydrate composition to release the gas; and generating energy from combustion of the gas or use of the gas in a fuel cell.

22. A method according to claim 21 wherein the gas is hydrogen or methane.

23. A method according to claim 22 wherein the gas is hydrogen generated by electrolysis of water.

24. A method for the separation of gases comprising the steps of: selecting a mixture of water and at least one semi-clathrate hydrate forming compound, capable of preferentially forming a semi-clathrate hydrate composition with a chosen gas contained in a mixture of gases; contacting a said mixture of gases, with a said selected mixture of water and at least one semi-clathrate hydrate forming compound, under semi-clathrate hydrate forming conditions to form a semi-clathrate hydrate composition preferentially comprising the chosen gas.

25. A method according to claim 24 wherein the chosen gas is carbon dioxide.

26. A method according to claim 24 further comprising the step of releasing the chosen gas from the semi-clathrate hydrate composition by heating and/or reducing pressure.

27. A fuel cell for the generation of electricity from hydrogen wherein the hydrogen is obtained from a semi-clathrate hydrate composition comprising hydrogen according to claim 1.

28. An automobile powered by a fuel cell generating electricity from hydrogen according to claim 27.

29. A method of removing impurities from an aqueous phase comprising the steps of: selecting a mixture of water and at least one semi-clathrate hydrate forming compound capable of preferentially including a chosen impurity in a semi-clathrate hydrate composition; contacting an aqueous phase containing the impurity with a said selected mixture under semi-clathrate hydrate forming conditions to form a semi-clathrate hydrate composition comprising the impurity; and separating the semi-clathrate hydrate composition from the aqueous phase.
